(19) United States
(12) Patent Application Publication
(10) Pub. No.: US 2008/0144217 A1
(43) Pub. Date: Jun. 19, 2008

(54) PATTERNED MAGNETIC RECORDING MEDIUM AND METHOD OF MANUFACTURING THE SAME

(75) Inventors: Myung-bok LEE, Yongin-si (KR); Jin-seung Sohn, Seoul (KR); Chee-kheng Lim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/861,348

(22) Filed: Sep. 26, 2007

(30) Foreign Application Priority Data
Dec. 15, 2006 (KR) 10-2006-0128942

(51) Int. Cl. G11B 5/74; G11B 23/00

(52) U.S. Cl. 360/131

(57) ABSTRACT

Provided are a patterned magnetic recording medium and a method of manufacturing the same. The patterned magnetic recording medium include: a substrate; and a plurality of magnetic recording layers arranged at predetermined intervals, wherein the magnetic recording layers are formed of an alloy including Co, Pt, and Ni. The patterned medium having the magnetic recording layers have an excellent read/write characteristic and high corrosion resistance and recording density.

### CROSS-REFERENCE TO RELATED PATENT APPLICATIONS

This application claims the benefit of Korean Patent Application No. 10-2006-0128942, filed on Dec. 15, 2006, in the Korean Intellectual Property Office, the disclosure of which is incorporated herein in its entirety by reference.

### BACKGROUND OF THE INVENTION

1. Field of the Invention

The present invention relates to a recording medium and a method of manufacturing the same, and more particularly, to a patterned magnetic recording medium and a method of manufacturing the same.

2. Description of the Related Art

Recently, as user usage information increases, a demand for a magnetic recording medium having a high recording density has been increased.

In the case of a continuous magnetic recording medium (hereinafter, referred to as a continuous medium) in which a continuous magnetic layer is used as a recording layer, the magnetic grain size of the magnetic layer must be reduced, in order to increase a recording density. However, if the magnetic grain size of the magnetic layer is reduced to be less than a critical value in the continuous medium, a superparamagnetic effect occurs. Thermal stability of the magnetic grain is reduced by the superparamagnetic effect. This means that the preservation characteristic of data recorded on the continuous medium is deteriorated. Thus, it is difficult to increase the recording density of the continuous medium by reducing the magnetic grain size of the magnetic layer.

As a scheme for exceeding the recording density limit of the continuous medium, a patterned magnetic recording medium (hereinafter, referred to as a patterned medium) in which magnetic domains corresponding to bit regions are isolated from one another has been suggested. The recording density of the patterned medium is known to be about 1 terabit/in² or higher which is much higher than the continuous medium.

It is preferable that a recording layer of a patterned medium in which data is recorded has a magnetization easy axis that is perpendicular to a substrate and thus has vertical magnetic anisotropy. The vertical magnetic anisotropy of the magnetic layer can be obtained by giving shape magnetic anisotropy to the magnetic layer by increasing the aspect ratio of the magnetic layer or by giving crystalline magnetic anisotropy to the magnetic layer by controlling the crystalline orientation direction of the magnetic layer. However, realizing a magnetic layer having a large aspect ratio is difficult. Thus, it is desirable to impart crystalline magnetic anisotropy to the magnetic layer by controlling the crystalline orientation direction of the magnetic layer. Magnetic layers having vertical magnetic anisotropy by virtue of crystalline magnetic anisotropy include CoP, a CoPt alloy having a disordered phase and a CoPt or a FePt alloy having an L1₀ ordered phase, or the like. CoP can be formed through electroless plating or electroplating, but has a comparatively low crystalline magnetic anisotropy energy. Thus, CoP may not be suitable for use in a high-density recording medium. The CoPt or FePt alloy having an L1₀ ordered phase has a high crystalline magnetic anisotropy energy. However, a high-temperature annealing process at 500° C. or higher is needed to obtain an ordered phase. Thus, the processes are complicated and inter-diffusion between layers may occur. Meanwhile, in case of the CoPt alloy having a disordered phase, layers can be formed at a low temperature of 100° C. or lower through electroplating and the CoPt alloy has comparatively high crystalline magnetic anisotropy. An alkaline plating solution is used when the CoPt alloy is formed by electroplating in conventional art. As such, the CoPt alloy contains a small amount (up to several per cent) of phosphorous (P).

However, a patterned medium (hereinafter, referred to as a conventional patterned medium) having a CoPt layer, which contains P, as a recording layer, has the following problems.

First, P usually exists at a grain boundary. P that exists at the grain boundary causes grain boundary corrosion and thus deteriorates corrosion resistance of a medium. As such, the reliability of the medium is lowered.

Second, P that exists at the grain boundary in the conventional patterned medium may deteriorate the magnetization reversal characteristic of a magnetic domain. In order to improve the read/write characteristic and recording density of a magnetic recording medium, the magnetization direction of the magnetic domain may be reversed by coherent rotation. This means that the magnetization directions of crystalline grains of the magnetic domain are simultaneously reversed. However, P that exists at the grain boundary is conducive to magnetically separate the crystalline grains from one another and thus disturbs coherent rotation. Thus, there are difficulties in conventional art when realizing a patterned medium having an excellent read/write characteristic and a high recording density.

### SUMMARY OF THE INVENTION

The present invention provides a patterned magnetic recording medium having excellent corrosion resistance and magnetization reversal characteristic.

The present invention also provides a method of manufacturing the patterned magnetic recording medium.

According to an aspect of the present invention, there is provided a patterned magnetic recording medium, the medium comprising: a substrate; and a plurality of magnetic recording layers arranged at intervals, on the substrate, wherein the magnetic recording layers are formed of an alloy including Co, Pt, and Ni.

The alloy may be CoNiPt.

Content (X)(atomic %) of Co in CoNiPt may be 70≦X<90, content (Y)(atomic %) of Pt may be 10≦Y<30 and content (Z)(atomic %) of Ni may be 0<Z≦20.

The recording medium may further comprise an underlayer disposed between the substrate and the magnetic recording layer, the underlayer being formed of a soft magnetic layer and an intermediate layer.

The intermediate layer may have a hexagonal close packed (HCP) or face centered cubic (FCC) structure.

The intermediate layer having the HCP structure may have a (002) surface parallel to the substrate.

The intermediate layer having the FCC structure may have a (111) surface parallel to the substrate.

According to another aspect of the present invention, there is provided a method of manufacturing a patterned magnetic recording medium, the medium comprising a substrate and a plurality of magnetic recording layers arranged at intervals, on the substrate, the method comprising: forming an underlayer on the substrate; forming a non-magnetic template on the underlayer, the non-magnetic template having a plurality of holes through which the underlayer is exposed; and filling the holes with a magnetic layer, the magnetic layer including Co, Pt, and Ni.

The magnetic layer may be formed by an electroplating method.

An electrolyte used in the electroplating method may include Co²⁺, Pt²⁺, and Ni²⁺ and concentration x, y, and z (mol/L) of Co²⁺, Pt²⁺, and Ni²⁺, respectively, may satisfy 3≦(x+y)/z<100. The underlayer may comprise a soft magnetic layer and an intermediate layer, which is disposed on the soft magnetic layer.

The intermediate layer may have a hexagonal close packed (HCP) or face centered cubic (FCC) structures.

The intermediate layer having the HCP structure may have a (002) surface parallel to the substrate.

The intermediate layer having the FCC structure may have a (111) surface parallel to the substrate.

The template may be formed by nano imprinting method.

A magnetic field may be applied to the substrate in a direction perpendicular to the substrate while the magnetic layer is being formed.

According to the present invention, grain boundary corrosion of the magnetic layer can be suppressed and the vertical coercive force and the magnetization reversal characteristic of the magnetic layer can be improved. Thus, the patterned recording medium according to an embodiment of the present invention has excellent reliability and read/write characteristic and has a high recording density of 1 terabit/in² or higher.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a patterned magnetic recording medium according to an embodiment of the present invention;

FIGS. 2A through 2C are cross-sectional views illustrating a method of manufacturing the patterned magnetic recording medium in FIG. 1, according to an embodiment of the present invention;

FIG. 3 is a phase diagram of a Co—Ni alloy;

FIG. 4 is a graph showing a change of a vertical coercive force of a magnetic layer according to the concentration of nickel sulfate in an electrolyte; and

FIG. 5 is a graph showing a change of squareness of a magnetic layer according to the concentration of nickel sulfate in an electrolyte.

### DETAILED DESCRIPTION OF THE INVENTION

The present invention will now be described more fully with reference to the accompanying drawings, in which exemplary embodiments of the invention are shown. In the drawings, the thicknesses of layers and regions are exaggerated for clarity. Like reference numerals in the drawings denote like elements.

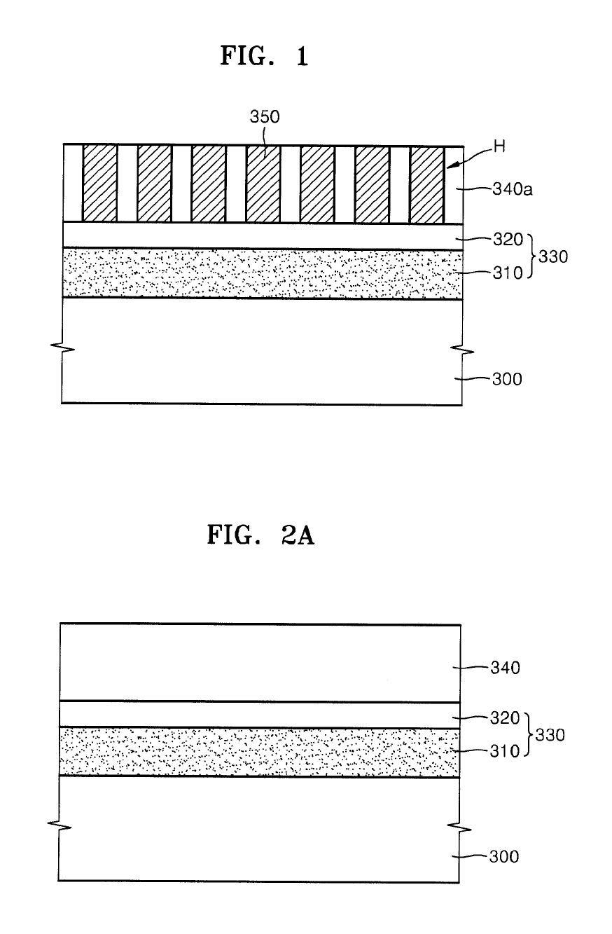

FIG. 1 is a cross-sectional view of a patterned magnetic recording medium (hereinafter, referred to as a patterned medium) according to an embodiment of the present invention.

Referring to FIG. 1, an underlayer 330 is formed on a substrate 300, and a non-magnetic template 340a is disposed on the underlayer 330. A plurality of holes H through which the underlayer 330 is exposed and which form an array, are formed in the template 340a. The substrate 300 may be one of a silicon substrate, a glass substrate, and an aluminum alloy substrate. The underlayer 330 may be a structure in which a soft magnetic layer 310 and an intermediate layer 320 are sequentially stacked. The soft magnetic layer 310 may be one of a CoZrNb layer, a NiFe layer, a NiFeMo layer, and a CoFeNi layer and the thickness thereof may be about 5-300 nm. The intermediate layer 320 may be a non-magnetic layer. The intermediate layer 320 may be a metal layer having a hexagonal close packed (HCP) or face centered cubic (FCC) structure. For example, the intermediate layer 320 may be one of Ti, Ru, Pt, Cu, and Au and the thickness thereof may be several to several tens of nano meters (nm). In addition, the intermediate layer 320 may have an HCP (002) oriented surface having small lattice parameter mismatch with a magnetic layer 350 that will be later formed, or an FCC (111) oriented surface that is equal to the HCP (002) oriented surface. As such, the orientation characteristic of the magnetic layer 350 that will be formed on the intermediate layer 320 can be improved.

The holes H of the template 340a are filled with the magnetic layer 350. The magnetic layer 350 is a recording layer in which data is recorded, and may be an alloy including Co, Pt, and Ni, for example, CoNiPt. The content X (atomic %) of Co in CoNiPt may be 70≦X<90 and the content Y (atomic %) of Pt may be 10≦Y<30, and the content Z (atomic %) of Ni may be 0<Z≦20. The thickness of the magnetic layer 350 may be about 10-200 nm. The magnetic layer 350 has an HCP structure and is orientated so that the crystalline direction of a direction perpendicular to the substrate 300 is <002>. In this way, the magnetic layer 350 shows vertical magnetic anisotropy.

Meanwhile, a seed layer (not shown) may be further provided between the substrate 300 and the underlayer 330, so as to adhere the substrate 300 and the underlayer 330. The seed layer may be formed by a deposition method known in the art, for example, sputtering. The seed layer may be formed of one of Ta, Cr, and Ti. In this case, the thickness of the seed layer may be about 5-20 nm.

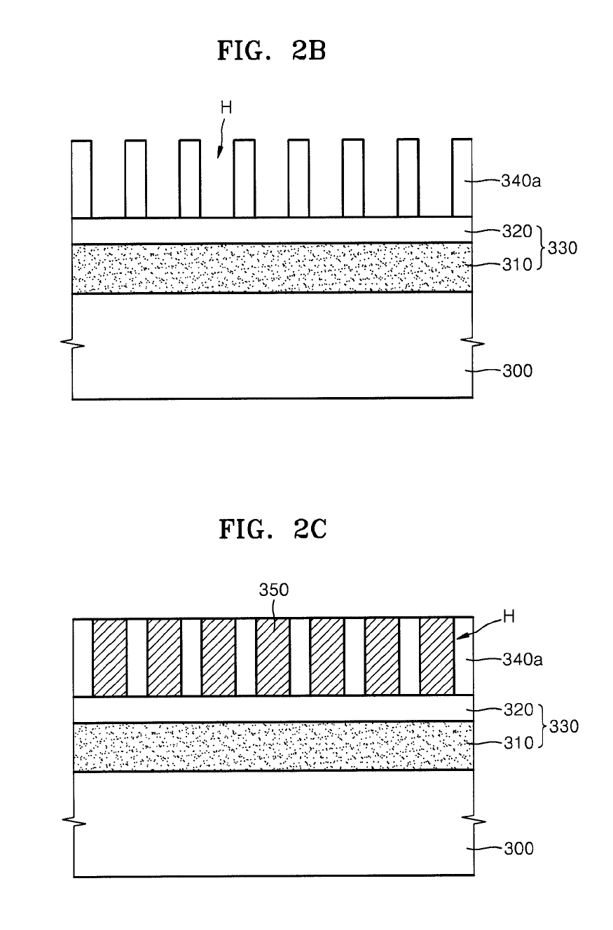

A method of manufacturing the patterned medium illustrated in FIG. 1 will now be described with reference to FIGS. 2A through 2C.

Referring to FIG. 2A, a underlayer 330 is formed on a substrate 300, and a resin layer 340, such as a photosensitive layer, is coated onto the underlayer 330. The underlayer 330 may be formed by sequentially stacking a soft magnetic layer 310 and an intermediate layer 320 on the substrate 300. A seed layer (not shown) may be formed between the substrate 300 and the underlayer 330 to a thickness of about 5-20 nm. The seed layer may be formed of one of Ta, Cr, and Ti, by sputtering.

Referring to FIG. 2B, a template 340a including a plurality of holes H through which the underlayer 330 is exposed, is formed by patterning the resin layer 340. The template 340a is a non-magnetic layer. The plurality of holes H are formed to form an array. The template 340a may be formed by coating a photosensitive layer onto the underlayer 330 and then by patterning the photosensitive layer using one of lithography methods, such as electron beam lithography, lithography using interference of ultraviolet (UV) or laser, natural lithography using anode oxidation or diblock copolymer, or nano sphere lithography using nano particles.

In addition, the template 340a may be formed using nano imprint. Specifically, a master stamp is manufactured through nano patterning including the lithography methods, and subsequently, the resin layer 340, such as a photosensitive layer, is coated onto the underlayer 330. Then, the resin layer 340 is imprinted using the master stamp, is patterned in nano scale and therefore, the plurality of holes H are formed.

Such a nano imprint process is simple and economical and thus is suitable for mass production. However, when the holes H are formed using the nano imprint process, a part of the resin layer 340 may remain on the bottom of the holes H. The resin layer 340 that remains on the bottom of the holes H may be removed through reactive ion etching (RIE) or plasma ashing.

Referring to FIG. 2C, the holes H are filled with the magnetic layer 350. The magnetic layer 350 may be formed through an electroplating method. An electrolyte used in the electroplating method includes a Co source, a Pt source, and a Ni source. Metallic salt containing Co, such as cobalt sulfate (CoSO₄.7H₂O), cobalt chloride (CoCl₂.6H₂O) or cobalt sulfamate [Co(SO₃NH₂)₂.XH₂O], may be used as the Co source. Metallic salt containing Pt, such as chloroplatinic acid (H₂PtCl₆.6H₂O), dinitrodiamine platinum [Pt(NO₂)₂(NH₃)₂.XH₂O], platinum chloride (PtCl₄.5H₂O) or dinitrosulfate platinum [(H₂Pt(NO₂)₂SO₄), may be used as the Pt source. Metallic salt containing Ni, such as nickel sulfate (NiSO₄.7H₂O) and nickel chloride (NiCl₂.6H₂O), may be used as the Ni source. When concentration (mol/L) of Co²⁺, Pt²⁺, and Ni²⁺ in the electrolyte is x, y, and z, respectively, x, y, and z may satisfy 3≦(x+y)/z<100. In addition, the electrolyte may further include a complexing agent for complexing Co ion and Pt ion and a potential of hydrogen (pH) adjuster for pH adjustment. The complexing agent may be cyanate, rochelle salt (KNaC₄H₄O₆.4H₂O), ammonate, ethylenediaminetetraacetic acid (EDTA)(C₁₀H₁₆N₂O₈), pyrophosphate, citrate, triethanol amine or boron fluoride and the pH adjuster may be sodium hydroxide (NaOH) or ammonia water (NH₄OH).

Meanwhile, an external magnetic field may also be applied to a direction perpendicular to the substrate 300 while electroplating is performed. In this case, the orientation characteristic and vertical magnetic anisotropy of the magnetic layer 350 are further improved.

Next, the surface of the magnetic layer 350 may be planarized by a planarization process, for example, a chemical mechanical polishing (CMP) or burnishing process. Subsequently, a protective layer, such as diamond like carbon (DLC), may be formed on the template 340a and the magnetic layer 350 and a lubricant may be applied to the protective layer.

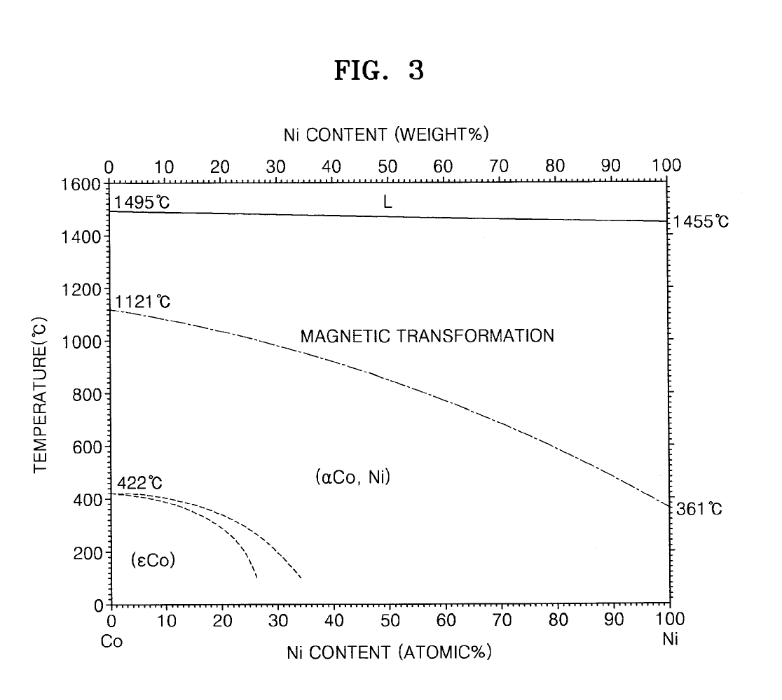

The magnetic layer 350 of the patterned medium according to an embodiment of the present invention includes nickel (Ni). From a phase diagram of a Co—Ni binary alloy as shown in FIG. 3, it is speculated that Ni does not exist at a crystalline grain boundary. Rather, it is thought that Ni and Pt are present in Co crystal.

Referring to FIG. 3, the HCP structure of Co is not changed and the Co crystal can hold about 25 atomic % of Ni at the normal temperature. Thus, in the patterned medium according to the present invention, corrosion of the magnetic layer 350 at a crystal grain boundary is suppressed, resulting in the improvement of the reliability of the patterned medium.

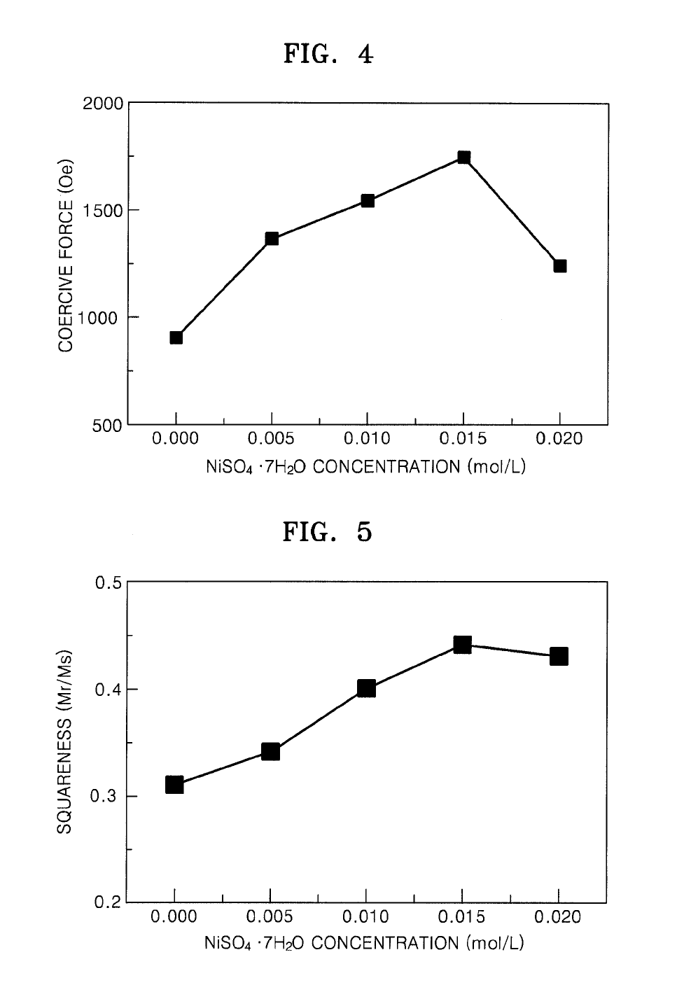

In addition, Ni plays a role for increasing a vertical coercive force of the magnetic layer 350 and does not magnetically separate crystalline grains. As such, the magnetization reversal characteristic of the magnetic layer 350 is excellent. Such an effect can be understood from FIGS. 4 and 5.

FIG. 4 shows the measurement result of a vertical coercive force of a magnetic layer according to concentration of nickel sulfate (NiSO₄.7H₂O) which is an Ni source in the electrolyte. For the measurement, 0.12 mol/L cobalt sulfate (CoSO₄.7H₂O), 0.01 mol/L chloroplatinic acid (H₂PtCl₆.6H₂O), 0.4 mol/L ammonium citrate [(NH₄)₂HC₆H₅O₇] and 0.2 mol/L sodium hydroxide (NaOH) were used as the Co source, the Pt source, the complexing agent, and the pH adjuster, respectively. And, the current density used in electroplating was 10 mA/cm² and the temperature of the electrolyte was 40° C. In addition, concentration (mol/L) of nickel sulfate (NiSO₄.7H₂O) was increased from 0 to 0.02 by 0.005. For experimental conveniences, in the state where an SiO₂ layer, a Cr layer, and an Au layer are sequentially stacked on a silicon substrate, the magnetic layer was formed on the Au layer by electroplating.

Referring to FIG. 4, a vertical coercive force of the magnetic layer formed by adding nickel sulfate (NiSO₄.7H₂O) to the electrolyte is larger than a vertical coercive force of the magnetic layer formed without adding nickel sulfate (NiSO₄.7H₂O) to the electrolyte. In particular, the vertical coercive force of the magnetic layer was about 1.8 times higher than the vertical coercive force of the magnetic layer formed without nickel sulfate (NiSO₄.7H₂O) when the concentration of nickel sulfate (NiSO₄.7H₂O) was 0.015 mol/L.

FIG. 5 is a graph showing a change of squareness of a magnetic layer according to the concentration of nickel sulfate (NiSO₄.7H₂O) in an electrolyte. Here, squareness means the ratio (Mr/Ms) of a remaining magnetization quantity (Mr) to a saturation magnetization quantity (Ms) in a magnetic hysteresis curve of the magnetic layer. As squareness increases, the magnetization reversal characteristic of the magnetic layer is improved.

Referring to FIG. 5, squareness of the magnetic layer formed by adding nickel sulfate (NiSO₄.7H₂O) to the electrolyte is larger than squareness of the magnetic layer formed without nickel sulfate (NiSO₄.7H₂O). When the concentration of nickel sulfate (NiSO₄.7H₂O) was approximately 0.015 mol/L, a maximum squareness was obtained.

As described above, in the patterned magnetic recording medium according to the present invention, the magnetic layer 350 is a CoNiPt layer, and Ni and Pt in the CoNiPt layer are present in Co crystal. As such, grain boundary corrosion of the magnetic layer 350 can be suppressed and the reliability of the medium can be improved.

In addition, the magnetic layer 350 includes Ni and has an HCP structure having a crystalline direction <002> which is perpendicular to the substrate and, thus, a vertical coercive force and squareness are improved. Thus, the patterned magnetic recording medium having the magnetic layer 350 as a recording layer according to an embodiment of the present invention may have an excellent read/write characteristic and have a high recording density of 1 terabit/in² or higher.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A patterned magnetic recording medium comprising:
a substrate; and
a plurality of magnetic recording layers arranged at intervals, on the substrate,
wherein the magnetic recording layers are formed of an alloy including Co, Pt, and Ni.

2. The medium of claim 1, wherein the alloy is CoNiPt.

3. The medium of claim 2, wherein content (X)(atomic %) of Co in CoNiPt is 70≦X<90, content (Y)(atomic %) of Pt is 10≦Y<30 and content (Z)(atomic %) of Ni is 0<Z≦20.

4. The medium of claim 1, which further comprises an underlayer disposed between the substrate and the magnetic recording layer, the underlayer being formed of a soft magnetic layer and an intermediate layer.

5. The medium of claim 4, wherein the intermediate layer has a hexagonal close packed (HCP) or face centered cubic (FCC) structure.

6. The medium of claim 5, wherein the intermediate layer having the HCP structure has a (002) surface parallel to the substrate.

7. The medium of claim 5, wherein the intermediate layer having the FCC structure has a (111) surface parallel to the substrate.

8. A method of manufacturing a patterned magnetic recording medium, the medium comprising a substrate and a plurality of magnetic recording layers arranged at intervals, on the substrate, the method comprising:
forming an underlayer on the substrate;
forming a non-magnetic template on the underlayer, the non-magnetic template having a plurality of holes through which the underlayer is exposed,; and
filling the holes with a magnetic layer including Co, Pt, and Ni.

9. The method of claim 8, wherein the magnetic layer is formed by an electroplating method.

10. The method of claim 9, wherein an electrolyte used in the electroplating method includes Co²⁺, Pt²⁺, and Ni²⁺ and concentrations x, y, and z (mol/L) of Co²⁺, Pt²⁺, and Ni²⁺ satisfies 3≦(x+y)/z<100.

11. The method of claim 8, wherein the underlayer comprises a soft magnetic layer and an intermediate layer, which is disposed on the soft magnetic layer.

12. The method of claim 11, wherein the intermediate layer has a hexagonal close packed (HCP) or face centered cubic (FCC) structure.

13. The method of claim 12, wherein the intermediate layer having the HCP structure has a (002) surface parallel to the substrate.

14. The method of claim 12, wherein the intermediate layer having the FCC structure has a (111) surface parallel to the substrate.

15. The method of claim 8, wherein the template is formed using nano imprinting method.

16. The method of claim 9, wherein a magnetic field is applied to the substrate in a direction perpendicular to the substrate while the magnetic layer is being formed.
